(19) United States
(12) Patent Application Publication
(10) Pub. No.: US 2016/0148534 A1
(43) Pub. Date: May 26, 2016

(54) System and Method for Continuous Video Review

(71) Applicant: Thomas Russell Howell, Los Ranchos, NM (US)

(72) Inventor: Thomas Russell Howell, Los Ranchos, NM (US)

(21) Appl. No.: 14/548,591

(22) Filed: Nov. 20, 2014

(51) Int. Cl. G09B 19/00; H04N 5/44; G06T 7/20; H04N 5/232; G09B 5/02; G06K 9/00

(52) U.S. Cl. CPC G09B 19/0038; G09B 5/02; G06K 9/00342; G06T 7/20; H04N 5/23293; H04N 5/44; G06T 2207/30221

(57) ABSTRACT

The present invention is a digital video capture and display system which enables one or more users, along with other observers, to see how an activity appears from a viewpoint of interest. The invention delays the video by some amount before it is displayed at a review station. This allows a user to perform an activity within the field of view of a video camera, and then to proceed to a review station where he or she can watch the video of his or her own recently performed activity.

### BACKGROUND OF THE INVENTION

1. Field of the Invention

The present invention is in the field of physical activity review. More particularly, the present invention is in the field of video systems for physical activity review.

2. Description of the Prior Art

It can be very difficult to learn new physical skills. A person attempting to learn a new physical skill may not have a clear sense of his or her position or movement, and frequently depends on a coach to provide feedback, for example; “keep our chin up”, “keep your toes pointed”. “straighten your wrist”, etc..

Still photography or video recording can be helpful, but they have several problems:
Review of the photographs or video may be delayed, until long after the training is completed.
The location convenient to review the photos or video may be distant from the location where it is possible to capture the images from the relevant point of view, for example; from the judge's point of view for gymnastics training.
Reviewing recorded images may require manipulation of the imaging apparatus, for example, replaying the video from the beginning of the exercise, or re-starting the camera in preparation for the next exercise. This manipulation of the imaging apparatus can be disruptive to the learning process if done by the user, and causes use of the system to be expensive if a system operator is required.
One user's review of recorded images may prevent use of the system by another user at the same time.

Products are commercially available for reviewing physical activities, but their requirements to record and replay video segments of interest, or to review the video at the location of the camera, make the systems cumbersome and intrusive to use during activity training.

The commercial product “Coach's Eye” by TechSmith Corporation is widely used for video review of sports training. The “Coach's Eye” product allows the user to record and analyze video on a mobile device. The product allows comparison of two performances with split screen video during analysis. Incorporated video drawing tools allow highlighting of areas for improvement. Key moments may be repeatedly reviewed, including slow-motion video playback.

The “Coach's Eye” product has deficiencies in three ways:
Video clips of physical activities are recorded, and must be re-played to be examined by the trainee. The process of retrieving and reviewing the video clip disrupts the user's training routine.
Retrieving and reviewing the video clips causes the video capture by the device to be stopped. This prevents the device from capturing the video of another trainee when a trainee is reviewing his or her video.
The “Coach's Eye” product uses a single device for capture and review of the training video. It is often important during physical activity training to see the activity from a specific point of view. An example is that it might be important to see the physical activity from an overhead perspective. The “Coach's Eye” product, which uses the same device for capture and review, would require the trainee to either retrieve the video device from an inconvenient location, or to go to that inconvenient location to review the video. Either of these disrupts the training.

The commercial product “Bust a Move” by OrangeQube is an application for smartphones and tablets, and can be used for physical activity training. The product allows delayed review of video imaged captured by the device camera.

The product “Bust a Move” is deficient for continuous video review of activities because it uses a single device for capture and review of the training video. It is very often the case that the vantage point of interest may be in a location that is inconvenient or inaccessible for the user during routine training. “Bust a Move” requires the user to go to the location of the camera device after each activity to review the video for that activity. If the point of view of interest for the activity is overhead, for example, then “Bust a Move” would require the user to move to the location of the camera, after each attempt at the activity in order to review the video. Requiring the video to be reviewed in the same physical location where the camera is placed is a deficiency which seriously limits the usefulness of this product.

U.S. Pat. No. 6,038,368 describes a system for acquiring, reviewing, and editing sports video segments. A computer system is provided for recording, processing, and distributing video information. The computer system includes a bus for driving compressed digital video and audio information and compressed digital information associated therewith. The computer system also includes at least one digital video camcorder, a processor, a memory, and a user interface. The computer system preferably further includes a mass storage device including a database. The database stores video information and digital information associated with the video information. The computer system also includes a deck for recording and playing information received from the DVCR and from the mass storage device.

The system described by U.S. Pat. No. 6,038,368 is deficient because video clips of physical activities are recorded, and must be re-played to be examined by the trainee. The process of retrieving and reviewing the video clip disrupts the training routine. Retrieving and reviewing the video clips also causes the video capture by the device to be stopped. This prevents the device from capturing the video of a second trainee when a first trainee is reviewing his or her video.

U.S. Pat. No. 5,879,246 describes an informational/training video system which provides a video-based, combined informational/training system for user activity related applications. In one embodiment, the system includes a video recording assembly and a measuring device located at a user activity site such as a tee box of a golf driving range. A video tape, including activity specific information on a first, pre-recorded portion thereof, is provided to the user for use in the video recording assembly at the user activity site. The video tape is cued for recording user specific information on a second portion of the video tape during a practice session. The sensor determines corresponding parameter information, such as estimated golf ball carry distance, for display on video tape. The video tape and video recording assembly cooperate to provide a mechanism for preventing or discouraging use of unauthorized tapes and to ensure proper usage of the system.

The system described by U.S. Pat. No. 5,879,246 is deficient because video clips of physical activities are recorded, and must be retrieved in order to be re-played and examined by the trainee. The process of retrieving and reviewing the video clip disrupts the training routine. Retrieving and reviewing the video clips also causes the video capture by the device to be stopped. This prevents the device from capturing the video of a second trainee when a first trainee is reviewing his or her video.

U.S. Pat. No. 8,289,185 describes a sports telemetry system for collecting performance metrics and data which include measuring, at one or more sensor modules mounted, affixed, or embedded on at least one sports participant, data corresponding to identification, movement, position, or condition of the at least one sports participant; broadcasting, from one or more telemetry modules mounted, affixed, or embedded on the at least one sports participant, signals carrying the data corresponding to identification, movement, position, or condition of the at least one sports participant.

The system described by U.S. Pat. No. 8,289,185 is not suited to the usage envisioned for the present invention because it requires one or more sensors to be affixed to the trainee, This is intrusive, time-consuming, and is not required by the present invention.

### SUMMARY OF THE INVENTION

The present invention is a digital video capture and display system which enables one or more users, along with other observers, to see how an activity appears from a viewpoint of interest. The invention delays the video by some amount before it is displayed at a review station. This allows a user to perform an activity within the field of view of a video camera, and then to proceed to a review station where he or she can watch the video of his or her own recently performed activity,

It is therefore a primary object of the present invention to allow a user of the system to review his or her own performance of an activity in order to be able to more rapidly learn to perform the activity, As an example; a user might be trying to learn to perform a forward flip into a pool from a springboard in preparation for a springboard diving competition. The present invention would allow the user to do the dive, and after exiting the pool to proceed to a review station where a delayed video would allow the user to see what his or her recently-completed dive looked like. This rapid feedback allows the user to identify any defects in technique, and to attempt to correct those defects when repeating the dive.

It is also a primary object of the present invention to allow a user to review his or her performance of an activity as it appears from the vantage point of interest. Many competitive activities such as gymnastics or figure skating are scored by judges. It is important for athletes training in those activities to be able to see how their performances appear from the vantage point of the judges. The present invention allows the camera to be placed so that the user will see how the activity will appear to judges during competitions.

Another object of the present invention is to allow the user to quickly and easily review his or her performance of an activity with a minimum of disruption to the training activity. The present invention allows the display station to be located remotely from the camera station. This allows the system user to review his or her performance of an activity at a location convenient to the user in the course of his or her training.

It is another object of the present invention to provide an aid to users so that they may learn to teach themselves, and to be less dependent upon coaches to provide feedback about the quality of their activities.

It is another object of the present invention to provide trainers or coaches with an additional means of giving feedback to trainees. It is commonplace to say that: “Each student learns differently”. Providing a means for a student to see his or her own performance of an activity may help some students in a way that getting verbal feedback from a coach does not.

It is a further object of the present invention to be able to provide visual feedback to a user at low cost. The present invention does not require an operator to run the camera or to run a video recorder. No operator intervention with the system is requited during training. The video at the display station is continuously delayed allowing the user to perform an activity within the field of view of the camera, and then to proceed to a review station where, after the delay time that has been set by the user, the video of his or her recent performance is presented. After the user has seen his or her performance he or she is free to try the activity again, all without having to manipulate the system in any way. The system will continue to capture, delay and display whatever happens in the field of view. This can reduce the reliance on continuous coaching, thereby reducing cost.

It is still a further object of the invention to allow simultaneous use of the system by one or more users. An example of this usage could be in review of ballet training. Several ballet dancers could be practicing independent passages within the field of view of the camera. As each one completes his or her passage, he or she could proceed, independently of the other dancers, to the review station to watch him or herself perform the passage. The other dancers could proceed to the review station at their own pace. Each one can use the system to capture and to review his or her own performance without interrupting another dancer.

It is an object of the present invention to allow transmission of the video stream to be accomplished securely. This allows users to be able to use the system while being confident that video of their performances are not viewable by an unintended audience. Secure transmission of the video stream from the capture station to the display station via a data network can be provided by password-protecting the transmission so that only users with the appropriate password credentials have access to the video stream.

Advantages of the present invention include, without limitation:
that the present invention allows a user to routinely view his or her performance of an activity with minimal interruption to a training routine;
that the present invention may be used by more than one user simultaneously without interfering with another user's use;
that the present invention does not require intervention after the video is started and the delay time set;
that the present invention allows the user to see his or her performance from the viewpoint of interest;
that the present invention allows the display station to be placed at a location different from the camera location, while allowing the monitor to be placed at a location convenient for the users during the course of their performance of the activities being reviewed.

These and other objects of the present invention will become apparent to those skilled in this art upon reading the accompanying description, drawings, and claims set forth herein. The headings provided herein are for the convenience of the reader only. No headings should be construed to limiting upon the content in any way.

### BRIEF DESCRIPTION OF THE DRAWINGS

FIG. 1 is a perspective view showing how the present invention is used in a training session;

FIG. 2 is a flow chart showing the handling of the video image by the major components of the present invention;

FIG. 3 is a perspective drawing showing one possible embodiment with two cameras looking from two different viewpoints displaying delayed video streams on two monitors at the display station.

FIG. 4 is a flow chart showing one possible embodiment where the video stream is delayed before transmission over the data network to the display station.

### DETAILED DESCRIPTION OF THE INVENTION

1. Definitions

“Video stream” as used herein refers to the continuously flowing stream of data which encodes video images captured by a digital video camera. Streaming video can be displayed without being recorded, similar to the way that a live television program can be viewed without its having been recorded.

“Delay” as used herein shall mean a length of time by which the display of the video stream follows behind the “live” video stream being captured by the video camera.

“User” as used herein shall mean a person using the system to review physical activities. One or more users may use the system concurrently without interrupting use of the system by other users.

2. Best Mode of the Invention

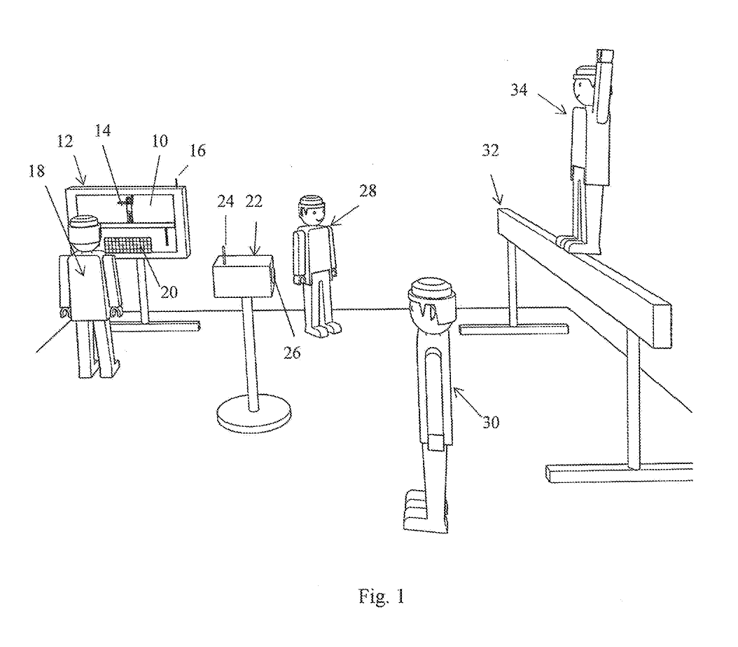

In broad embodiment, as shown in FIG. 1, the best mode contemplated by the inventor of the present invention comprises a video capture and transmit station 22 communicating with a display station 12. Together these elements allow one or more users to execute physical activities within the field of view of the camera 26, which is an element of the capture and transmit station 22, and then to proceed to the display station 12 where a video image of those activities, having been delayed by a user-defined length of time, will be displayed so the user can observe the activity that he or she recently completed.

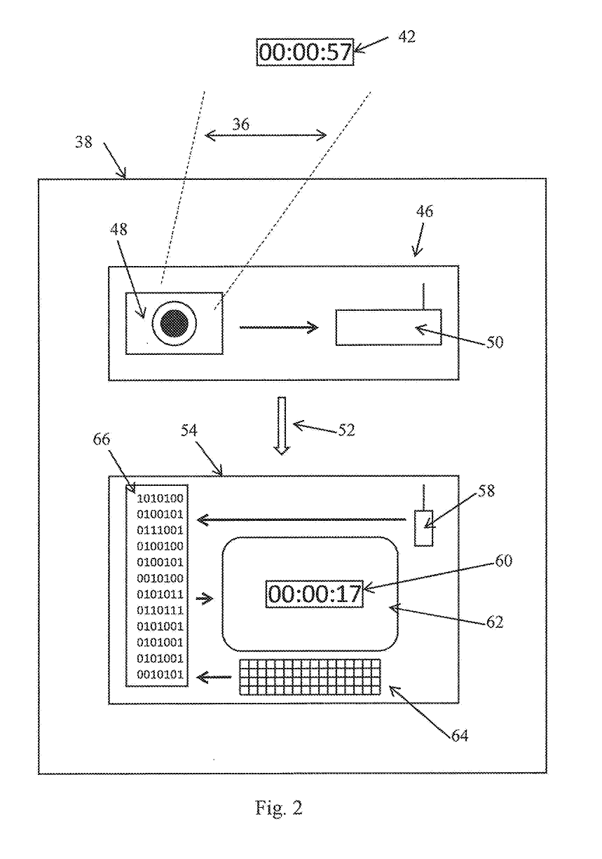

FIG. 2 shows a flow diagram describing the best mode contemplated by the inventor of the system for Continuous Video Review of Activities according to the concepts of the present invention.

Referring again to FIG. 2, the operation of the present invention 38, including the capture, transmission, delay and display of a video image are described. The capture and transmit station 46 contains a digital camera 48 with a connection to a data transmitter 50. The capture and transmit station 46 transmits a digital video stream 52 to the display station 54. Within the display station 54 the video stream is received by a receiver 58 which sends the digital video stream to a processor 66 capable of digitally delaying the video stream before it is sent to the display device 62 where it is displayed to the user. The display station incorporates an input device 64 which allows the user to command a delay time to be used by the processor 66. The delay time is set so as to allow a user time to perform an activity within the field of view of the camera and to move to the display station to see the activity as it was performed. The video stream processor 66 accepts the user's requested delay time and delays the video display by that amount.

Still referring to FIG. 2, the video image that is displayed 60 shows the user what was happening in within the field of view 36 of the camera 48. Activities within the field of view 36 will be seen at the display station 54 after the requested delay time. If, for example, there is a clock 42 within the field of view 36, the image of the clock 60 that is shown at the display station 54 will have been delayed by the user-defined delay time.

3. How to Make the Invention

Without limiting the scope of the invention, a specific embodiment which would allow one of ordinary skills to make and use an example of the present invention could be constructed as follows:
A digital camera producing an H.264 encoded output stream can be connected by a LAN cable of ordinary type to a digital signal router. An example of a digital camera suitable for this purpose is a Foscam F19805W. An example of a suitable router is a Netgear WNR2000.
A laptop PC of an ordinary type, running a Windows or Apple or Linux operating system may be used for the display station.
The laptop must have a networking capability allowing it to receive the signal transmitted by the router.
A software package allowing streaming display of a video signal must be installed on the computer. Open source software with this capability is freely available. An example of such a package is the VLC Media Player. The VLC media player is a free and open source cross-platform multimedia player and framework that plays most multimedia files as well as DVDs, Audio CDs, VCDs, and various streaming protocols.
The video display software must have the capability to delay the display of a video stream. VLC has that capability.

With the hardware and software described above, a system demonstrating the capabilities of the present invention can be constructed.

4. How to Use the Invention

Referring again to FIG. 1, the invention is shown in use by athletes practicing physical activities. The invention comprises a station 22 for capturing and transmitting a video image of an athlete practicing his or her activity, and an image display station 12 where an athlete can see what his or her activity looked like.

Still referring to FIG. 1, a typical process for performing and reviewing a physical activity is shown. A user moves one or more times through a sequence of performing and reviewing an activity. A user in position 34 is doing an activity, while a video image is being captured by the image capture station 22. A user in position 30, having completed his or her activity, is moving away from the practice station 32, and is moving toward the video review station 12. A user at the display station 12 is watching a video image of his or her recently-completed activity. A trainee at position 28 is waiting to enter the field of view of the camera 26 to perform an activity after the user at position 34 is finished.

Still referring to FIG. 1, an important part of the present invention is that the video image which is captured at station 22 is delayed in time before being displayed at station 12. The length of time by which the video stream is delayed is set at the beginning of the exercise so that it is sufficient for a user to do an activity and to proceed to the review station. With the delay time set in this way, after completing the exercise and proceeding to the display station 12, the user will be able to see his or her own activity being displayed.

Still referring to FIG. 1, an important part of the present invention is that the image can be captured from a viewpoint where the quality of performance of the skill can be most clearly seen. In many sports, gymnastics or springboard diving, for example, the quality of a performance will be assessed by one or more judges during competition. The present invention allows the camera 26, a part of the capture and transmit station 22, to be placed so that the viewpoint of the camera will most accurately capture the viewpoint of interest.

Still referring to FIG. 1, an important part of the present invention is that the display station 12 can be placed at a convenient location with respect to the location of performance of the activity 32. The ability to place the display station at a location convenient for the user is an important part of the invention as it allows review of the activity at display station 12 to be minimally-disruptive to repeated performances of the activity.

5. Alternative Embodiments of the Invention

The present invention can be built in different embodiments while still maintaining the attributes of the invention. It is possible to build the present invention so that the transmit station and the display station communicate either by wired or by wireless networking. In either embodiment the system retains the attributes which make it a useful invention.

Additional embodiments may include fixed installations or portable systems. In a fixed installation embodiment the capture and transmit station may be installed in a fixed location relative to the location of the user's practice. In a portable embodiment both the capture and transmit station and the display station can be made portable, and can be moved from event to event (as in gymnastics, where trainees practice on different apparatus). Either embodiment has the attributes which make this a useful invention.

The present invention may be built to be either AC or DC powered. A fixed-installation system may be well-suited for AC power. A portable system may be more flexible if a battery-powered approach is taken. These embodiments have the same functionality that has been previously described for the present invention.

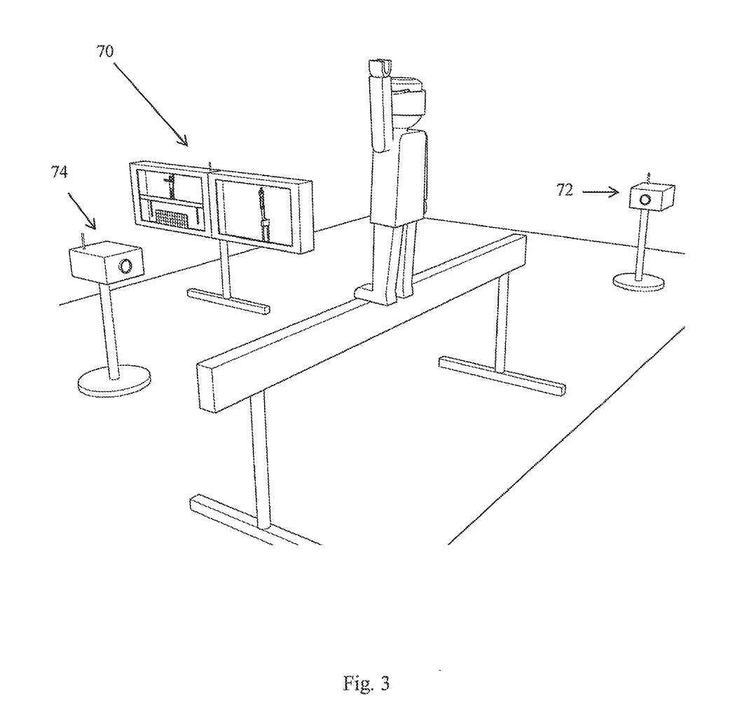

Another possible embodiment of the present invention is a multi-camera embodiment. When practicing some physical activities (for example, gymnastics training on the balance beam apparatus) two different views of the athlete's position and movements may be helpful. As shown in FIG. 3, it is easily possible with the present invention to have a camera perpendicular to the balance beam 74, and another camera taking an end-on view of the balance beam 72. These two cameras can transmit video streams to a display station 70. It is also possible, at the display station, to have a monitor for each view; one for the perpendicular view, and one for the end-on view. These embodiments have the same functionality that has been previously described for the present invention.

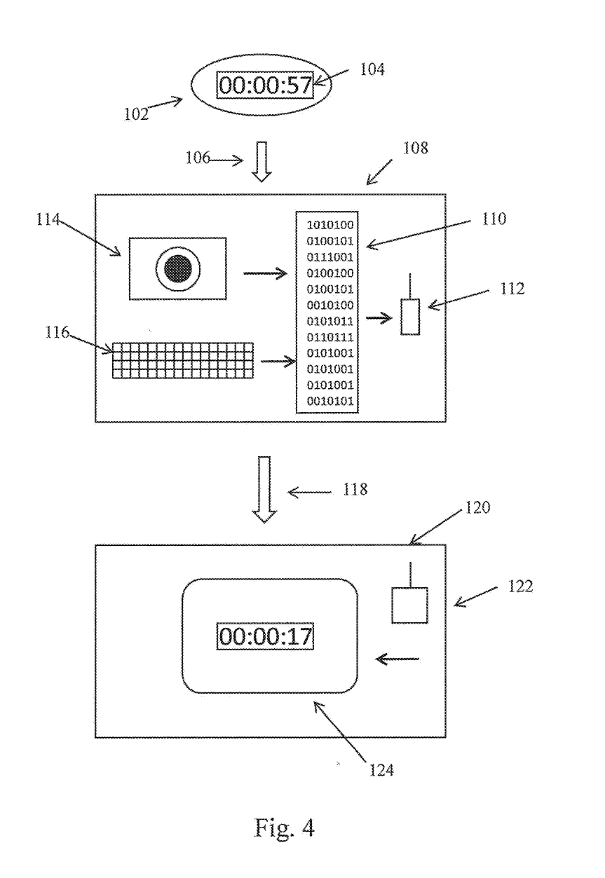

Another possible embodiment of the present invention is shown in FIG. 4. In this embodiment the processor 110 with software capable of delaying the video stream is placed in the capture and transmit station 108, and the video stream is delayed before being transmitted to the display station 120. This embodiment has all the functionality and attributes that have been previously described for the present invention.

6. Examples of the Invention

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed.

What is claimed is:

1. A system for continuous video review comprising:
a digital video camera;
the capability for converting the video captured by said digital video camera to an encoded digital video stream;
a data network capable of transmitting said encoded digital video stream to a display station;
said display station having a viewing device capable of displaying the video stream;
a computer with software capable of delaying said video stream by an amount defined by the user;
said computer also having an input device allowing the user to define the delay time;
wherein the overall system allows a user to review video captured by the digital camera after said video has been delayed by a user-defined length of time, and after the video has been transmitted to the display station.

2. A system for continuous video review according to claim 1, wherein said data network allows the video camera at the capture station to be placed in a location such that the video image represents a viewpoint of interest, for example, but not limited to, the viewpoint from which the judge in a physical activity competition would view the activity.

3. A system for continuous video review according to claim 1, wherein said data network provides the capability for secure transmission of the video stream, and prevents access to the video stream by users who do not have the required passwords or other required credentials.

4. A system for continuous video review according to claim 1, wherein said data network allows said display station to be placed in a location that is convenient to the user, and which may be at a distance from the capture station.

5. A system for continuous video review according to claim 1, wherein said delay time is adjustable by the user to allow the activity to be completed, and to allow time for the user to move to the display station to see the delayed video of the activity just performed.

7. A system for continuous video review according to claim 1, wherein said viewing device, a part of said display station, may be of any type capable of displaying said video stream, including but not limited to LED or LCD screens, CRT screens, projectors, or other display devices.

8. A system for continuous video review according to claim 1, wherein one or more cameras communicating to one or more display devices give the user the ability to watch the activity under review from one or more points of view.

9. A system for continuous video review according to claim 1, wherein the system runs continuously after the delay time is set by the user, and which requires no other operator intervention during the user's repeated performance of activities and review of those performances.

10. A system for continuous video review according to claim 1, wherein the transmission of the video stream from the capture station to the display station is password protected, and said transmission may not be reviewed other than at a display station where a user has entered the required password.

11. A system for continuous video review according to claim 1, wherein the transmission of the digital video data stream may be done wirelessly.

12. A system for continuous video review according to claim 1, wherein either the video capture station or the display station, or both, may be at fixed locations, or may be portable.

13. A system for continuous video review according to claim 1, wherein either the video capture station or the display station, or both, may be battery powered, and therefore not require connection to AC power.

14. Use of a system according to claim 1 as a tool providing feedback to the user for the purpose of learning to perform an activity, with the rapid and continuous visual feedback from the system being valuable to rapid learning.

15. A method for video review of activities, comprising the steps:
capturing video images by a video camera placed at a vantage point of interest;
converting said video images to a digital video data stream;
transmitting said digital video data stream by a data network from the capture station to a display station;
delaying said video data stream by a length of time set by the user;
displaying said delayed video stream at a display station;
wherein the method allows the user to review video images captured by the video camera after said video images have been transmitted to said display station, and after said video images have been delayed by a user-defined length of time.

16. A method for continuous video review according to claim 15, wherein one or more users may independently use the system without disrupting use of the system by other users.

17. A method for continuous video review according to claim 15, wherein one or more reviewers other than, and in addition to, the performer of an activities to be reviewed, for example coaches of said performer, are also able review the delayed video stream and provide feedback to said performer.

18. A method for continuous video review according to claim 15, wherein the person reviewing the video images at the display station may be the same person that performed the activities being reviewed within the field of view of the camera.

19. A method for continuous video review according to claim 15, wherein review of the delayed video of a activity does not require the user or another operator to operate controls of the system, therefore allowing a more seamless integration of repeated performance and activity review into a feedback and learning process for the activity.
